(19) United States
(12) Patent Application Publication
(10) Pub. No.: US 2025/0088006 A1
(43) Pub. Date: Mar. 13, 2025

(54) TECHNOLOGIES FOR ENERGY STORAGE DRIVEN SYNCHRONOUS CONDENSERS

(71) Applicant: Non-Synchronous Energy Electronics, LLC, St. Louis Park, MN (US)

(72) Inventor: Alan McDonnell, Hopkins, MN (US)

(21) Appl. No.: 18/434,157

(22) Filed: Feb. 6, 2024

Related U.S. Application Data
(60) Provisional application No. 63/581,437, filed on Sep. 8, 2023.

(51) Int. Cl. H02J 3/38; H02P 6/08

(52) U.S. Cl. CPC H02J 3/38; H02P 6/08; H02J 2203/10

(57) ABSTRACT

Technologies for power grid regulation include a synchronous machine coupled to a high voltage power grid, an induction motor mechanically coupled to the synchronous machine, a power converter coupled to the induction motor, and an energy storage device coupled to the power converter. A controller may be configured to regulate torque of the induction motor by controlling output of the power converter. The controller may selectively cause the power converter to transfer energy from the energy storage device to the induction motor and to transfer energy from the induction motor to the energy storage device. The controller may regulate speed of the induction motor using a shaft speed sensor coupled to the induction motor. The controller may be configured to cause the power converter to start rotation of the induction motor when the high voltage power grid is not energized. Other embodiments are described and claimed.

### CROSS-REFERENCE TO RELATED APPLICATIONS

The present application claims priority under 35 U.S.C. § 119(e) to U.S. Provisional Application Ser. No. 63/581,437, filed Sep. 7, 2023, the entire disclosure of which is hereby incorporated by reference.

### BACKGROUND

The utility power grid has an operational need to provide frequency stability. It typically does this by controlling governor operations on large, turbine-driven synchronous machines. Additionally, the existing power grid has protection and control schemes that rely on rotating synchronous machines to provide fault current in the event of a grid fault somewhere in the system, thus allowing for the sensing of fault currents to open breakers, or simply to provide large amounts of current to burn fuse elements and open fuses. Currently, more and more synchronous machines that are driven by coal/steam or natural gas turbines are being shut down, and the percentage of power generation from inverter based resources (IBRs) is increasing. Under these conditions, the stability of the grid and the existing protection and control schemes may not be adequate.

Typical inverter based resources, such as from wind turbines, solar arrays or battery energy storage systems cannot generally provide sufficient fault current, and thus grid operators may install expensive free-wheeling synchronous machines into the grid, known in the industry as synchronous condensers. These synchronous condensers also provide system inertia to the utility grid by providing a net energy flow if the utility grid frequency changes quickly, such as a frequency dip from a generator tripping off-line. This helps provide damping and stability while the other generator throttles adjust their power output, or battery energy storage systems can sense the frequency dip and start supplying net energy to the utility grid. Additionally, grid operators may run gas turbine driven synchronous generators in order to provide these services, as well as fast reserve power and system damping, even though the net energy produced by those generators is not required and the fuel burned to run the turbine is largely wasted.

### SUMMARY

According to one aspect of the disclosure, a system for power grid regulation includes a synchronous machine coupled to a high voltage power grid, an induction motor having an output shaft mechanically coupled to a rotor of the synchronous machine, a power converter coupled to the induction motor, and an energy storage device coupled to the power converter. In an embodiment, the system further includes a plurality of energy storage devices including the energy storage device, and a plurality of power converters including the power converter. Each energy storage device of the plurality of energy storage devices is coupled to a corresponding power converter of the plurality of power converters via a direct current link, and each power converter of the plurality of power converters is coupled to the induction motor via an alternating current link. In an embodiment, the synchronous machine comprises an alternator.

In an embodiment, the system further comprises a controller coupled to the power converter. The controller is configured to determine a target motor torque, determine a target stator frequency for the induction motor to achieve the target motor torque, and control the power converter to achieve the target stator frequency. In an embodiment, the controller is further configured to determine a direct current (DC) set-point to achieve the target motor torque, and control the power converter to achieve the DC current set-point. In an embodiment, the controller is configured to selectively cause the power converter to transfer energy from the energy storage device to the induction motor and to selectively cause the power converter to transfer energy from the induction motor to the energy storage device.

In an embodiment, the system further includes a shaft speed sensor coupled to the output shaft of the induction motor. The controller is further coupled to the shaft speed sensor and the controller is configured to regulate speed of the induction motor using the shaft speed sensor by controlling output of the power converter. In an embodiment, the shaft speed sensor comprises an encoder. In an embodiment, the controller is configured to stabilize a grid frequency of the high voltage power grid with the induction motor.

In an embodiment, the controller is configured to cause the power converter to start rotation of the induction motor when the high voltage power grid is not energized. In an embodiment, the controller is further configured to cause an inverter-based, grid-following energy storage system to transfer energy to the high voltage power grid after causing the power converter to start rotation of the induction motor.

In an embodiment, the synchronous machine is further coupled to an inverter-based, grid-following energy storage system. In an embodiment, the energy storage device comprises one or more batteries, and the power converter comprises one or more inverters coupled to the batteries.

In an embodiment, the synchronous machine has a power rating of 50-70 MVA and an operating voltage of about 13.8 kV, and the induction motor has a power rating of +/−20 MW at a speed of 3600 RPM (+/−1 RPM).

According to another aspect, a method for power grid regulation comprises regulating, by a controller, torque of an induction motor; wherein an output shaft of the induction motor is mechanically coupled to a rotor of a synchronous machine, the synchronous machine is coupled to a high voltage power grid, a power converter is coupled to the induction motor, and an energy storage device is coupled to the power converter; and wherein regulating the torque of the induction motor comprises controlling output of the power converter.

In an embodiment, regulating the torque of the induction motor further comprises controlling output of a plurality of power converters including the power converter, wherein each power converter of the plurality of power converters is coupled to a corresponding energy storage device of a plurality of energy storage devices including the energy storage device via a direct current link, and wherein each power converter of the plurality of power converters is coupled to the induction motor via an alternating current link. In an embodiment, the synchronous machine comprises an alternator. In an embodiment, regulating the torque of the induction motor comprises determining a target motor torque; determining a target stator frequency for the induction motor to achieve the target motor torque; and controlling the power converter to achieve the target stator frequency. In an embodiment, regulating the torque of the induction motor further comprises determining a direct current (DC) set-point to achieve the target motor torque; and controlling the power converter to achieve the DC current set-point.

In an embodiment, the method further comprises selectively causing, by the controller, the power converter to transfer energy from the energy storage device to the induction motor; and selectively causing, by the controller, the power converter to transfer energy from the induction motor to the energy storage device. In an embodiment, the method further comprises regulating, by the controller, speed of the induction motor using a shaft speed sensor coupled to the output shaft of the induction motor, wherein the shaft speed sensor comprises an encoder. In an embodiment, the method further comprises stabilizing, by the controller, a grid frequency of the high voltage power grid with the induction motor.

In an embodiment, the method further comprises causing, by the controller, the power converter to start rotation of the induction motor when the high voltage power grid is not energized. In an embodiment, the method further comprises causing, by the controller, an inverter-based, grid-following energy storage system to transfer energy to the high voltage power grid after causing the power converter to start rotation of the induction motor.

In an embodiment, the synchronous machine is further coupled to an inverter-based, grid-following energy storage system. In an embodiment, the energy storage device comprises one or more batteries, and wherein the power converter comprises one or more inverters coupled to the batteries.

In an embodiment, the synchronous machine has a power rating of 50-70 MVA and an operating voltage of about 13.8 kV; and the induction motor has a power rating of +/−20 MW at a speed of 3600 RPM (+/−1 RPM).

According to another aspect, a device for power grid regulation comprises an energy storage device, a power converter coupled to the energy storage device, and a controller coupled to the power converter. The controller is configured to regulate torque of an induction motor by controlling output of the power converter. An output shaft of the induction motor is mechanically coupled to a rotor of a synchronous machine, and the synchronous machine is coupled to a high voltage power grid.

In an embodiment, the device further comprises a plurality of energy storage devices including the energy storage device, and a plurality of power converters including the power converter. Each energy storage device of the plurality of energy storage devices is coupled to a corresponding power converter of the plurality of power converters via a direct current link, and each power converter of the plurality of power converters is coupled to the induction motor via an alternating current link. In an embodiment, the synchronous machine comprises an alternator.

In an embodiment, the controller is configured to determine a target motor torque, determine a target stator frequency for the induction motor to achieve the target motor torque, and control the power converter to achieve the target stator frequency. In an embodiment, the controller is further configured to determine a direct current (DC) set-point to achieve the target motor torque, and control the power converter to achieve the DC current set-point. In an embodiment, the controller is configured to selectively cause the power converter to transfer energy from the energy storage device to the induction motor and to selectively cause the power converter to transfer energy from the induction motor to the energy storage device. In an embodiment, the controller is configured to regulate speed of the induction motor using a shaft speed sensor coupled to the output shaft of the induction motor, wherein the shaft speed sensor comprises an encoder. In an embodiment, the controller is configured to stabilize a grid frequency of the high voltage power grid with the induction motor.

In an embodiment, the controller is configured to cause the power converter to start rotation of the induction motor when the high voltage power grid is not energized. In an embodiment, the controller is further configured to cause an inverter-based, grid-following energy storage system to transfer energy to the high voltage power grid after causing the power converter to start rotation of the induction motor.

In an embodiment, the energy storage device comprises one or more batteries, and the power converter comprises one or more inverters coupled to the batteries.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for power grid regulation with an energy storage driven synchronous condenser;

FIG. 2 is a simplified block diagram of at least one embodiment of a system for power grid regulation including the system of FIG. 1 and an inverter-based battery energy storage system.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

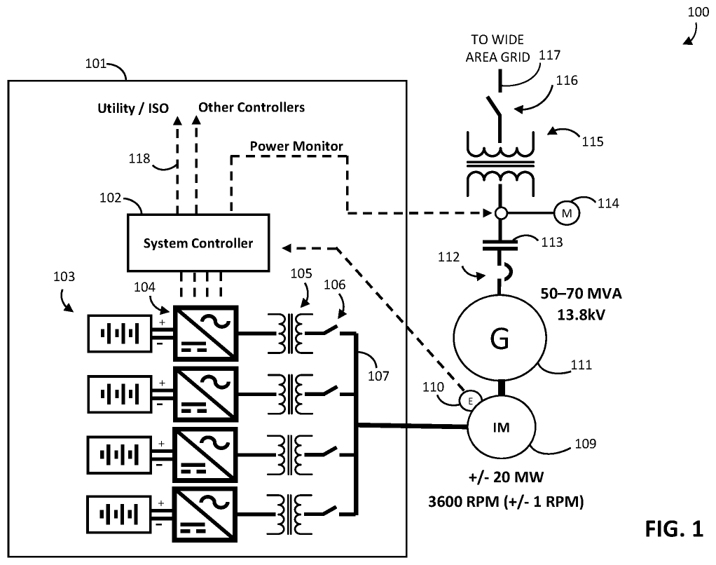

Referring now to FIG. 1, an example illustrative system 100 for power grid regulation includes a synchronous machine mechanically coupled to an induction machine that is driven by one or more power converters that can draw and supply power to one or more batteries. The synchronous machine is coupled to a high-voltage utility grid or other wide area power grid. In use, as described further below, a controller may control torque of the induction motor by controlling the power converters. The synchronous machine rotates and synchronizes to the bulk grid, and thus it is the frequency of the bulk grid that sets rotor speed of the synchronous machine. The torque control of the induction machine from the power converter uses small changes to the stator frequency, and is thus used to regulate the flow of energy to and from the batteries. The DC voltage control on the battery terminals follows this, up and down as energy is transferred to the battery or from the battery.

The system 100 may provide fault current to the power grid, which is not available from conventional inverter-based resources such as wind farms, solar farms, or battery energy storage systems. Further, the system 100 may provide this fault current at a lower cost and without unnecessary fuel usage as compared to conventional gas turbine-driven free-wheeling synchronous machines. Additionally, the system 100 may provide system inertia or otherwise improve frequency stability for the power grid by providing a net energy flow if the utility grid frequency changes quickly, such as a frequency dip from a generator tripping off-line. This helps provide damping and stability while the other generator throttles adjust their power output, or battery energy storage systems can sense the frequency dip and start supplying net energy to the utility grid. In particular, as described further below, the system 100 may react more quickly than conventional inverter-based resources that utilize phasor measurement units (PMUs).

As shown in FIG. 1, the system 100 includes an energy storage and system controller subsystem 101, which includes a system controller 102, multiple batteries 103, multiple power converters 104, transformers 105, switchgear 106, and an alternative current (AC) link or bus 107. The system controller 102 may be embodied as any type of control circuit or other device capable of performing the functions described herein. For example, the system controller 102 may be embodied as, without limitation, a programmable logic controller (PLC), a controller, a microcontroller, a microprocessor, a workstation, a server, a rack-mounted server, a blade server, a network appliance, a desktop computer, a laptop computer, distributed computing system, a multiprocessor system, and/or any other control circuit capable of performing the functions described herein. Additionally, in some embodiments, the controller 102 may be embodied as a distributed control system or other “virtual server” formed from multiple computing devices distributed across a network and operating in a public or private cloud.

Each of the batteries 103 may be embodied as a battery energy storage system (BESS) or other grid storage battery. For example, each battery may be embodied as a lithium iron phosphate battery or other battery suitable for stationary grid storage. Further, although illustrated in FIG. 1 as including four batteries 103, it should be understood that in utility-scale embodiments the system 100 may include many more batteries 103, e.g., hundreds of batteries 103. Additionally or alternatively, in some embodiments the system 100 may include one or more different energy storage devices such as supercapacitors or other energy storage systems.

Each of the power converters 104 may be embodied as a low-voltage, bidirectional AC-DC power converter. The DC side of each power converter 104 is connected to the battery packs 103. Each of the batteries 103 can operate within a DC voltage range appropriate for the power converter 104. The AC side of each power converter 104 is connected to the AC link 107 via the transformers 115 and switchgear 116. The transformers 105 convert AC power from the power converters 104 to a medium voltage suitable for the induction machine as described further below. As also described further below, the power converters may selectively supply energy from the batteries 103 to the induction machine or may selectively supply energy from the induction machine to the batteries 103.

The induction motor 109 is a medium voltage induction machine connected through the transformers 105 via the AC link 107 to several low voltage AC-DC power converters 104. In the illustrative embodiment, the induction motor 109 may have a power rating of about positive or negative 20 MW, and may operate at a rotational speed of 3600 RPM (±1 RPM). Additionally or alternatively, in some embodiments the induction motor 109 may operate at a different rotational speed such as 1800 RPM (±1 RPM). Additionally or alternatively, in still further embodiments the induction motor 109 may have a higher rating such as positive or negative 100 MW. As shown, the system 100 includes multiple low-voltage power converters 104 in parallel with the transformers 105, which enable the induction motor 109 (operating at a medium voltage) to operate with the batteries 103 (which operate at lower voltages, and may be limited to below about 1500 VDC). In some embodiments, the induction motor 109 may include a shaft encoder 110 mounted on an output shaft of the induction motor 109. The shaft encoder 110 connects by data link to the power converter system controller 102. The encoder 110 may be embodied as a shaft encoder, a rotary encoder, or other rotational speed sensor capable of measuring rotational speed of the induction motor 109. The encoder 110 may be an electromechanical, optical, electromagnetic, Hall effect, or other encoder.

The induction motor 109 is mechanically coupled to an alternator 111. The alternator 111 may be embodied as any synchronous alternator, generator, or other synchronous machine. In the illustrative embodiment, the alternator 111 has a capacity of 50-70 MVA and operates at 13.8 kV. The output shaft of the induction motor 109 is mechanically connected to a rotor shaft of the alternator 111. Accordingly, the induction motor 109 rotates at the same rotational speed as the synchronous machine 111. The alternator 111 is illustratively connected to a wide-area utility high voltage power grid 117 via a circuit breaker 112, synchronizing contacts 113, a step-up transformer 115, and a switch 116. Of course, in other embodiments, the alternator 111 may be connected to the power grid 117 via any other appropriate connection. The synchronous machine 111 is tied to the grid 117 and controls its field current in order to control VAR current flow. Field current of the synchronous machine 111 may be controlled using similar controls for field current as would be used by a conventional free-wheeling synchronous condenser.

As shown, a power meter 114 is coupled to the interface between the alternator 111 and the grid 117. The power meter 114 connects by data link to the system controller 102. The system controller 102 may also have one or more incoming and outgoing data links 118 to communicate with additional controllers from the grid operator(s), co-located energy storage assets, power monitoring, the synchronous field controller, and other operational and safety signals. In an embodiment, the system controller 102 may monitor and store data related to the operation of the system 100. This data may be usable for monitoring performance of the grid 117, for example grid frequency, stability, fault current, or other data.

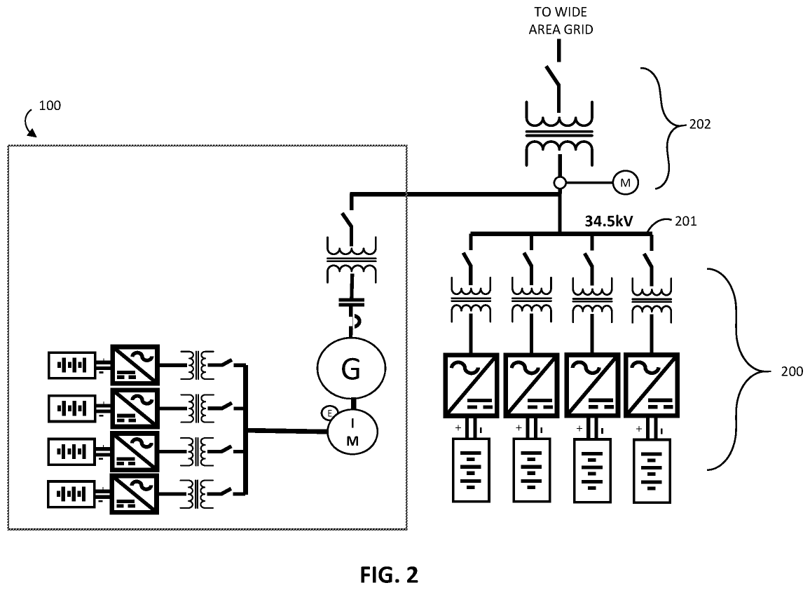

Referring now to FIG. 2, in some embodiments, the system 100 of FIG. 1 may be co co-located with a grid-following battery energy storage system (BESS) 200. The BESS 200 may be similar to a typical BESS system, of which many thousands of MW have now been installed. As shown, the output from the system 100 may be coupled to an AC bus 201 operating at 34.5 kV. This bus 201 is coupled to a high-voltage power grid 202 as described above. The system 100 and the BESS 200 may be controlled to work as one for utility integration and market participation purposes. The cost of the rotating machines 109, 111 of the system 100 may be significantly higher on a per unit basis as compared to a standard battery energy storage systems (BESS) 200. Thus, by combining the system 100 and the BESS 200 as shown in FIG. 2, cost, capacity, and/or performance may be optimized or otherwise improved.

In use, the system 100, 200 may be used to perform a method for regulating torque of induction motor 109. As described above, the rotor of the synchronous machine 111 is synchronized with the power grid 117, which sets the rotor speed. Torque control of power converters 104 (by controlling stator frequency of the induction motor 109) controls whether energy is transferred from batteries 103 to the grid 117 or from the grid 117 to the batteries 103. For example, given that the synchronous machine 111 is tied to the grid 117, which sets the speed of the synchronous machine 111, the power converters 104 may be programmed to provide a negative torque to the induction machine 109 (and by extension the synchronous machine 111). This turns the induction machine 109 into a motor thereby driving energy into the batteries 103 by having the power converters 104 raise the target DC voltage level to charge the batteries 103. In some embodiments, energy may be stored in the batteries 103 when costs for power from the wide area grid 117 are lower, for example during the daytime when large amounts of solar energy are available. The signal for torque control may originate from an outside controller that determines whether to charge or discharge the battery 103, similar to a system controller for the BESS 200.

Additionally or alternatively, in some embodiments the system 100, 200 may tightly regulate frequency of the induction motor 109. As described above, in some embodiments, the induction machine 109 includes a shaft encoder 110 that is fed back the power converter system controller 102. The controller 102 controls, through the power converters 104, the output frequency of the stator of the induction machine 109 to regulate the shaft speed of the induction machine 109. This in turn regulates the shaft speed of the synchronous machine 111.

Since the synchronous machine 111 is synchronized to the utility grid 117, its speed is also regulated by the utility grid 117. Accordingly, based on available power, the induction machine 109 is only able to make limited changes to the speed of the synchronous machine 111. The power of the induction machine 109 can be used to make very fast changes to the power flow in or out of the synchronous machine 111 if called upon, such as during a frequency dip, where the synchronous machine 111 follows the grid frequency and the shaft encoder 110 detects a very small change in speed. The controller 102 and the induction machine 109 then does what it can to try and force the speed of the induction motor 109 (and thereby the synchronous machine 111) back to the set-point. This brings very fast injections of real power into the frequency dip, helping to limit it or slow its rate of descent. This is in addition to the inertia of the joined rotors of the rotating machines 109, 111 injecting power as well.

The accuracy of the shaft encoder 110 for determining rotational speed may be considerably better than measuring the frequency of the AC grid 117 through a power monitor. For example, in an embodiment, the accuracy of the induction motor speed control with encoder feedback can be within 1 RPM, or 16.7 mHz (3600 RPM), which is much faster and more accurate than an inverter based system making or measuring a 60 Hz grid. Accordingly, the system 100 may see and act upon changes in frequency more quickly than systems that use a power monitor (such as a grid forming inverter). Accordingly, the system 100 may provide grid stability of a higher value than a similarly rated grid forming inverter based energy storage system. For example, in an embodiment, a grid operator may pay a reserve fee for systems that can detect a frequency dip to 59.85 Hz (from 60 Hz) and react within 250 ms, and the system 100 may be capable of measuring a much smaller frequency dip and reacting in a much faster time.

In an embodiment, the system 100 may transfer energy from the grid 117 into the batteries 103 by controlling induction motor 109 torque as described above. In this operating mode, speed from the encoder 110 may still be monitored, and if a dip is measured, then the power converters 104 can very quickly change mode and drive the induction machine 109 with power drawn from the batteries 103. Similarly, if the batteries 103 are being discharged, for instance due to advantageous market prices, but an over-frequency event occurs (e.g., due to loss of a big load), the power converters 104 can measure this and very quickly change modes to stop sending energy out of the batteries 103 and start absorbing energy into the batteries 103, to help keep the grid frequency stable.

In an embodiment, the system 100 may be used to perform a “black start” operation after a system wide grid loss. In this case, the induction motor 109 may drive the synchronous machine 111 to the proper speed for the power grid, and then be the first unit to energize the HV transmission line 117, up to the power available from the induction machine 109. After energizing the grid 117 using the synchronous machine 111, a co-located BESS 200 as shown in FIG. 2 could quickly synchronize to the grid 117 and then provide much more power as needed. Typically, such operations are performed by gas turbines. By performing black start operations, the system 100 may allow grid operators to increase the percentage of inverter-based resources (IBRs) in use.

In some embodiments, outer band controls to and from the system controller 102 may be used to send signals for set-points for stability performance, along with other signals for features such as black start. In some embodiments, the system controller 102 may be programmed to accept signals similar to that which are now sent to gas turbine generators. Accordingly, grid operators may integrate the system 100 into a control architecture similar to their existing control architecture.

The addition of an energy storage driven synchronous condenser as in the system 100 may provide the power grid with services and stability of a gas turbine, with tighter frequency control and load following capabilities, such as power flow control from the BESS system. Additionally or alternatively, in some embodiments, the system 100 may be used in conjunction with a traditional gas turbine-driven generator. In those embodiments, the energy storage driven condenser of the system 100 may run when the gas turbine-driven generator is shut down. In those embodiments, the system 100 and the gas turbine generator may also be connected in parallel with a BESS 200 as shown in FIG. 2. By matching the condenser of the system 100 to the gas turbine alternator, the interconnection studies and approvals may be vastly simplified, while keeping expected system performance that grid operators are familiar with. For example, the system 100 and the parallel BESS 200 may use an existing high voltage interconnection with the power grid. Once the energy storage driven synchronous condenser of the system 100 is installed, grid operators may keep it online for all of the hours that gas turbines are off. Additionally, by providing power grid services and stability with the system 100 (e.g., supplying fault current or primary frequency control and grid forming), gas turbine run times may be further reduced, which may reduce costs (e.g., by reducing fuel use, reducing unneeded power generation, etc.).

The penetration depth of inverter based resources (IBRs) when using grid-following inverters is limited. Thus, a large-scale power grid may be operated using grid forming inverters instead of synchronous generators. Spinning synchronous machines provide advantages over grid forming inverter solutions (e.g., value, responsiveness, fault current, etc.). However, many grid operators have installed simple synchronous condensers, which are rate based and provide no economic value that can be bid into the market. These machines may provide damping to the grid and fault current contribution, but may not provide frequency control or black start capability. Accordingly, when the amount of energy available from IBRs is sufficient, but grid stability, black start capability, or other services are required, the energy storage driven synchronous condenser of the system 100 provides an improved solution.

As described above, certain grid operators have installed (or have plans to install) free-wheeling synchronous condensers to help with grid stability and protection. The electro-mechanical lock of a synchronous machine rotor to the grid provides for much faster change measurements and response times than a control system that relies upon feedback measurement and then software analysis of an event. This includes the amount of fault current produced, and speed with which it is produced, given that the existing bulk grid is generally designed around synchronous generators and may require significant fault currents in order to quickly operate appropriate breakers and fuses in the system. Accordingly, changing from synchronous generators to IBRs in a conventional grid may require significant changes to the existing protection schemes. Such changes are expensive and complicated, and can therefore lead to problems in a critical area where no problems existed before the change. As a solution, many operators may add rate-based synchronous condensers despite the high costs, which must be passed along to consumers. Using the system 100 instead of a conventional synchronous condenser may reduce these costs, for example by adding grid stability services or other economic value that may be bid to the market.

As described above, with a synchronous machine rotor lock, even very small changes in frequency can be detected quickly and acted upon. This gives the induction motor driven synchronous condenser of the system 100 the ability to provide very fast and accurate grid forming primary frequency control. This control includes the capability of being the “first one on” in a black start situation. Once grid operators are given access to the stability enhancements available from the system 100, they will find them very useful as the build out of more solar power and other IBRs come on-line.

Thus, the system 100 is capable of supplying frequency stability, primary frequency control, or black start capabilities to a power grid as described above. Accordingly, the system 100 may include large scale energy storage suitable for providing and/or receiving substantial amounts of energy for sustained periods of time in order to perform one or more of those functions. Similarly, in order to provide services to the power grid, the system 100 includes a large-scale synchronous machine 111 which may have a capacity (e.g., 50-70 MVA in an illustrative embodiment) that is much larger (e.g., 10 times larger) as compared to small, low voltage (LV) motor/battery systems.

1. A system for power grid regulation, the system comprising:
a synchronous machine coupled to a high voltage power grid;
an induction motor having an output shaft mechanically coupled to a rotor of the synchronous machine;
a power converter coupled to the induction motor; and
an energy storage device coupled to the power converter.

2. The system of claim 1, further comprising:
a plurality of energy storage devices including the energy storage device; and
a plurality of power converters including the power converter;
wherein each energy storage device of the plurality of energy storage devices is coupled to a corresponding power converter of the plurality of power converters via a direct current link, and wherein each power converter of the plurality of power converters is coupled to the induction motor via an alternating current link.

3. The system of claim 1, further comprising:
a controller coupled to the power converter, wherein the controller is configured to:
determine a target motor torque;
determine a target stator frequency for the induction motor to achieve the target motor torque; and
control the power converter to achieve the target stator frequency.

4. The system of claim 3, wherein the controller is further configured to:
determine a direct current (DC) set-point to achieve the target motor torque; and
control the power converter to achieve the DC current set-point.

5. The system of claim 3, wherein the controller is configured to selectively cause the power converter to transfer energy from the energy storage device to the induction motor and to selectively cause the power converter to transfer energy from the induction motor to the energy storage device.

6. The system of claim 3, further comprising:
a shaft speed sensor coupled to the output shaft of the induction motor;
wherein the controller is further coupled to the shaft speed sensor, and the controller is configured to regulate speed of the induction motor using the shaft speed sensor by controlling output of the power converter.

7. The system of claim 6, wherein the controller is configured to stabilize a grid frequency of the high voltage power grid with the induction motor.

8. The system of claim 3, wherein the controller is configured to cause the power converter to start rotation of the induction motor when the high voltage power grid is not energized.

9. The system of claim 8, wherein the controller is further configured to cause an inverter-based, grid-following energy storage system to transfer energy to the high voltage power grid after causing the power converter to start rotation of the induction motor.

10. The system of claim 1, wherein the synchronous machine is further coupled to an inverter-based, grid-following energy storage system.

11. The system of claim 1, wherein:
the synchronous machine has a power rating of 50-70 MVA and an operating voltage of about 13.8 kV; and
the induction motor has a power rating of +/−20 MW at a speed of 3600 RPM (+/−1 RPM).

12. A method for power grid regulation, the method comprising:
regulating, by a controller, torque of an induction motor, wherein:
an output shaft of the induction motor is mechanically coupled to a rotor of a synchronous machine;
the synchronous machine is coupled to a high voltage power grid;
a power converter is coupled to the induction motor; and
an energy storage device is coupled to the power converter; and
wherein regulating the torque of the induction motor comprises controlling output of the power converter.

13. The method of claim 12, wherein regulating the torque of the induction motor comprises:
determining a target motor torque;
determining a target stator frequency for the induction motor to achieve the target motor torque; and
controlling the power converter to achieve the target stator frequency.

14. The method of claim 12, further comprising regulating, by the controller, speed of the induction motor using a shaft speed sensor coupled to the output shaft of the induction motor, wherein the shaft speed sensor comprises an encoder.

15. The method of claim 14, further comprising stabilizing, by the controller, a grid frequency of the high voltage power grid with the induction motor.

16. The method of claim 12, further comprising causing, by the controller, the power converter to start rotation of the induction motor when the high voltage power grid is not energized.

17. A device for power grid regulation, the device comprising:
an energy storage device;
a power converter coupled to the energy storage device; and
a controller coupled to the power converter, wherein the controller is configured to regulate torque of an induction motor by controlling output of the power converter;
wherein an output shaft of the induction motor is mechanically coupled to a rotor of a synchronous machine; and
wherein the synchronous machine is coupled to a high voltage power grid.

18. The device of claim 17, wherein the controller is configured to:
determine a target motor torque;
determine a target stator frequency for the induction motor to achieve the target motor torque; and
control the power converter to achieve the target stator frequency.

19. The device of claim 17, wherein the controller is configured to:
regulate speed of the induction motor using a shaft speed sensor coupled to the output shaft of the induction motor, wherein the shaft speed sensor comprises an encoder; and
stabilize a grid frequency of the high voltage power grid with the induction motor.

20. The device of claim 17, wherein the controller is configured to cause the power converter to start rotation of the induction motor when the high voltage power grid is not energized.
